(19) United States
(12) Patent Application Publication
(10) Pub. No.: US 2012/0048466 A1
(43) Pub. Date: Mar. 1, 2012

(54) EASY MIX MORTAR/GROUT COMPOSITION, METHOD OF MAKING AND USING THEREOF

(75) Inventors: David Eckert, Palatine, IL (US); Syed A. Mahmood, Lombard, IL (US); Bronwyn T. Miller, Belvidere, IL (US); Gregory W. Schad, Cary, IL (US)

(73) Assignee: H.B.Fuller Specialty Construction Products Inc., St. Paul, MN (US)

(21) Appl. No.: 12/872,546

(22) Filed: Aug. 31, 2010

(51) Int. Cl. B32B 37/12; C04B 16/04; B05D 3/00; C04B 16/02

(52) U.S. Cl. 156/336; 106/805; 524/8; 427/393.6

(57) ABSTRACT

A cementitious composition includes at least one cementitious material, at least one aggregate, from about 0.2% by weight to about 5% by weight of at least one superplasticizer, and from about 0.1% by weight to about 5% by weight of at least one water retention agent. The composition, upon mixing with an aqueous component, has an initial viscosity of no greater than about 150,000 cps, and a 20 minute viscosity of no less than about 250,000 cps.

### FIELD OF THE INVENTION

The invention relates to a cementitious composition that is particularly useful for an easy mix tile setting mortar or a grout.

### BACKGROUND OF THE INVENTION

Tiles, e.g., ceramic tiles or stones, are installed over a horizontal or a vertical surface/substrate with a Portland cement-based tile setting mortar. A thick layer of the mortar is applied to accommodate more uneven substrates and/or tile thickness variations. It also ensures sufficient moisture being present to properly hydrate the cement content and develop strength.

The tile setting mortar is typically delivered to the job site in dry powder form, and mixed with water or a liquid polymer latex to produce a wet consistent paste. After slaking for a period, the mortar is troweled over the surface/substrate to be tiled using a trowel, or a similar tool. The tiles are then placed into the wet mortar, aligned with tiles already set or other reference marks and beaten in until level. Once the tiles are firmly set, the joints or spaces between the set tiles are filled with a grout, typically cement-based also, using a rubber float or a similar device.

### SUMMARY OF THE INVENTION

In one aspect, the invention features a cementitious composition. The composition includes at least one cementitious material, at least one aggregate, from about 0.2% by weight to about 5% by weight of at least one superplasticizer, and from about 0.1% by weight to about 5% by weight of at least one water retention agent. The composition, upon mixing with an aqueous component, has an initial viscosity of no greater than about 150,000 cps, and a 20 minute viscosity of no less than about 250,000 cps.

In another aspect, the invention features a cement-based mortar/grout. The mortar/grout includes the aforesaid cementitious composition and from about 15% by weight to about 75% by weight of an aqueous component.

In one embodiment, the cement-based mortar/grout is a tile setting mortar.

In one embodiment, the cement-based mortar/grout is a grout.

In yet another aspect, the invention features a cement-based mortar/grout that includes a cementitious composition and a water-based admixture. The cementitious composition includes at least one cementitious material and at least one water retention agent; and the water-based admixture includes from about 0.5% by weight to about 20% by weight at least one superplasticizer, from about 0% by weight to about 10% by weight at least one water retention agent, and from about 0% by weight to about 10% by weight at least one accelerator. The cementitious composition and the water-based admixture are kept separate until at the point of use. The cement-based mortar/grout has, upon mixing the cementitious composition with the water-based admixture at the point of use, an initial viscosity of no greater than about 150,000 cps, and a 20 minute viscosity of no less than about 250,000 cps.

In yet another aspect, the invention features a method of making a cement-based mortar/grout. The method includes mixing a cementitious composition with an aqueous component to form a paste that has an initial viscosity of no greater than about 150,000 cps; allowing the paste to stand for a period, e.g., from about 10 to about 20 minutes so that the viscosity of the paste increases to no less than about 250,000 cps at about 20 minutes from the initial mixing. The cement-based mortar/grout includes at least one cementitious material, from about 0.2% by weight to about 5% by weight at least one superplasticizer, from about 0.1% by weight to about 5% by weight at least one water retention agent, and from about 0.01% by weight to about 10% by weight at least one accelerator.

In yet another aspect, the invention features a method for setting tiles. The method includes mixing, at the point of use, the aforesaid cementitious composition with an aqueous component to form a paste that has an initial viscosity of no greater than about 150,000 cps; allowing the paste to stand for a period, e.g., from about 10 minutes to about 20 minutes to form a mortar that has a viscosity of no less than about 250,000 cps when tested at about 20 minutes from the initial mixing; applying the mortar to a surface/substrate to be tiled; placing tiles on the top surface of the mortar; and curing the mortar to set the tiles.

In yet another aspect, the invention features a method for grouting a tile joint. The method includes mixing, at the point of use, the aforesaid cementitious composition with an aqueous component to form a paste that has an initial viscosity of no greater than about 150,000 cps; allowing the paste to stand for a period, e.g., from about 10 minutes to about 20 minutes to form a trowelable grout that has a viscosity of no less than about 250,000 cps at about 20 minutes from the initial mixing; applying the grout to the joint; and curing the grout.

In yet another aspect, the invention features a package for the aforesaid cementitious composition. The package includes an amount of the composition, and instructions including how to mix the composition with an aqueous component to obtain a mortar or a grout.

Conventional cement based tile setting mortars tend to be highly viscous and heavy, therefore, are typically mixed with a heavy duty mechanical mixer to achieve a uniform consistency prior to the application. Inventors discovered that many do-it-yourself homeowners do not have heavy duty mechanical mixers, which make it more difficult to mix tile setting mortars at home.

The cement-based mortar/grout of the invention, however, is formulated such that it has a very low initial viscosity, that is, no greater than about 150,000 cps, or even no greater than about 100,000 cps, relative to conventional mortars e.g., tile setting mortars, therefore, can be easily prepared at the customer end without the need to use a mechanical mixing device/force, especially heavy duty mechanical mixers. For example, the cement-based mortar/grout can be mixed by hand with a tool e.g., a margin trowel or paint stirrer by any individual at the point of use. At the end of the typical slaking period, e.g., in about 10 minutes to about 20 minutes, the viscosity of the cement-based mortar/grout quickly increases to the desired level, e.g., no less than about 250,000 cps, or no less than about 300,000 cps, which allows the user to use the mortar/grout in a timely fashion. The cement-based mortar/grout of the invention can be used as a tile setting mortar to set the tiles on a vertical surface/substrate e.g., a wall, or a horizontal surface/substrate, e.g., a floor, in the same manner as a conventional tile setting mortar, where the tiles would not slip on the wall or slump on the floor.

The cement-based mortar/grout of the invention also exhibits very well balanced performance properties. For example, the cement-based mortar/grout exhibits strong shear bond strength such that it may be capable of meeting, or even exceeding the American National Standard Specifications for Latex-Portland Cement Mortars for the Installation of Ceramic Tile, A118.4-1999 (reaffirmed 2005), and/or the American National Standard Specifications for EGP (Exterior Glue Plywood) Latex-Portland Cement Mortars for the Installation of Ceramic Tile, A118.11-1999 (reaffirmed 2005).

In some embodiments, the cement-based mortar/grout exhibits a shear bond strength of greater than about 200 psi, when tested by the American National Standard Specifications for EGP (Exterior Glue Plywood) Latex-Portland Cement Mortars for the Installation of Ceramic Tile, A118.11-1999 (reaffirmed 2005). In some embodiments, the cement-based mortar/grout exhibits a shear bond strength of greater than about 300 psi, when tested by the American National Standard Specifications for Latex-Portland Cement Mortars for the Installation of Ceramic Tile, A118.4-1999 (reaffirmed 2005).

### DETAILED DESCRIPTION OF EMBODIMENTS OF THE INVENTION

Unless noted otherwise, the following terms and/or phrases, as used herein, have the following meanings. Such terms/phrases may be explained in greater detail later in the specification.

The phrase “cementitious material” refers to an inorganic material that can be hydraulically set and harden, and that usually, but not exclusively includes Portland cement, calcium aluminates cement, masonry cement, or mortar cement, and may also includes anhydrous or hydrated gypsum (calcium sulphate), limestone, hydrated lime, fly ash, blast furnace slag, pozzolans, metakaolin, silica fume or other materials commonly included in such cements.

The phrase “cementitious composition” refers to an inorganic hydraulic composition that is in dry powder form and that is kept separate from water or any water containing components prior to the point of use. The cementitious composition includes at least one cementitious material such as cement and optionally other dry ingredients, and will harden, or cure, via a hydration reaction between the cementitious material and water upon mixing both together.

The terms “paste,” “mortar,” “grout”, and “concrete” are terms of the art in connection with hydraulic cementitious compositions, and refer to mixtures composed of water or a water-containing component and a hydraulic cementitious material. Mortars and grouts are pastes that may additionally include fine aggregate (e.g., sand); and “concretes” are mortars additionally including coarse aggregate (e.g., gravel, stones).

The terms “cement-based mortar/grout” refers to a cement-based mortar or a cement-based grout depending on the end use.

The term “tile” refers to various tiles including ceramic tiles, porcelain tiles, quarry tiles, glass tiles as well as other masonry products such as stone, bricks, pavers, and the like.

The term “aqueous component” refers to a component that includes water, e.g., water; water based solutions, emulsions, or dispersions for a cementitious composition; water based admixtures for a cementitious composition or a cementitious material; and combinations thereof.

The term “admixture” refers to a specifically formulated additive mixture that is added to a cementitious composition or a cementitious material to enhance the quality and durability of the cementitious composition or the cementitious material.

In one embodiment, the cementitious composition of the invention includes at least one cementitious material.

Examples of the suitable cementitious materials include various hydraulic cements e.g., various Portland cements e.g., gray or white Portland cements, pozzolanic cement, alumina cement, hydraulic lime, calcium aluminates cement, masonry cement, or mortar cement, and may also includes anhydrous or hydrated gypsum (calcium sulfate), limestone, fly ash, blast furnace slag, pozzolans, metakaolin, silica fume, and combinations thereof. Examples of a commercially available cementitious material include Lafarge Type I Portland cement from Lafarge Corp. (Herndon, Va.).

The cementitious material is present in the cementitious composition in an amount of from about 15% by weight, or from about 20% by weight, or from 25% by weight to about 70% by weight, or to about 80% by weight, or to about 90% by weight, based on the weight of the cementitious composition.

In one embodiment, the cementitious composition further includes at least one aggregate.

Examples of suitable aggregates include various fine and coarse aggregates e.g., silica sand, gravel, lime, calcium carbonate; various fillers including light weight fillers such as hollow ceramic spheres, hollow plastic spheres, glass beads, expanded plastic beads, diatomaceous earth, vermiculite, and combinations thereof.

Aggregate can be present in an amount of from about 5% by weight, or from about 15% by weight to about 55% by weight, or to about 65% by weight, based on the weight of the cementitious composition.

In some embodiments, the cementitious composition may include from about 5% by weight, to about 10% by weight, or to about 25% by weight, or to about 50% by weight, based on the weight of the cementitious composition, of one or more light weight fillers such as hollow ceramic spheres.

In one embodiment, the cementitious composition is substantially free of an aramid fiber, e.g., a poly (p-phenylene terephethalamide) polymer fiber (p-aramid), or poly (in-phenylene terephethalamide) polymer fiber (m-aramid).

In one embodiment, the cementitious composition further includes at least one superplasticizer.

Suitable superplasticizers include those cement dispersants that are designed specifically for cement, and that are high range water reducers. That is, they can reduce the water demand of a cementitious composition by from about 15% to about 40% relative to a cementitious composition without a water reducer.

Examples of the suitable superplasticizers include those that are commercially available in dry form, such as powdered superplasticizers, as well as those that are commercially available in liquid form. Superplasticizers in dry form can be mixed directly into the cementitious composition, or they can be mixed with water to form a water-based solution or dispersion prior to being mixed with the cementitious composition at the point of use. Superplasticizers in liquid form can be mixed with an aqueous component prior to being mixed with the cementitious composition at the point of use.

Examples of the suitable superplasticizers include such as polycarboxylate based superplasticizers, sulfonated melamine-formaldehyde condensate superplasticizers, casein, modified lignosulfonate superplasticizers, sulfonated naphthalene-formaldehyde condensate superplasticizers, and combinations thereof.

Examples of commercially available superplasticizers include Melflux® 1641F, Melflux® 2641F, Melflux® 2651F, Melment® F10, Melment® F15 from BASF Chemical Company (Kennesaw, Ga.); Type 500 Casein from International Casein (New Orleans, La.) and Peramin® CONPAC 149S and Peramin® CONPAC 500 from Kerneos Inc (Chesapeake, Va.).

The superplasticizer is present in the cementitious composition in an amount of up to about 5% by weight, or from about 0.2% by weight, or from about 0.3 by weight, or from about 0.4 by weight, or from about 0.5 by weight to about 2.5% by weight, or to about 3.5% by weight, or to about 4% by weight, or to about 5% by weight, based on the weight of the cementitious composition.

In some embodiments, the superplasticizer is present in the cementitious composition such that the weight ratio of the superplasticizer to the cementitious material is from about 0.002, or from about 0.005, or from about 0.008 to about 0.25, or to about 0.3 or to about 0.35.

In one embodiment, the cementitious composition further includes at least one water retention agent.

The water retention agent includes a first water retention agent, a second water retention agent, and combinations thereof. In some embodiments, the cementitious composition includes at least one first water retention agent. In some embodiments, the cementitious composition includes at least one second water retention agent. In some embodiments, the cementitious composition includes a combination of at least one first water retention agent and at least one second water retention agent.

The water retention agent is present in the cementitious composition in an amount of from about 0.1% by weight to about 5% by weight, based on the weight of the cementitious composition.

The first water retention agent is a water soluble cellulose ether. Examples of useful water soluble cellulose ethers include such as various degrees of substitution of alkyl derivatives of celluloses such as hydroxyethyl cellulose, methylhydroxyethyl cellulose, methylhydroxypropyl cellulose, and combinations thereof. Examples of commercially available water soluble cellulose ethers include Culminal® MHEC 15000 PFF, Culminal® MHEC 40000 PF, Culminal® MHPC 20000 PFR, Culminal® C4051, Culminal® C9155, and Combizell® LK 70M, Combizell® LH 40M, Combizell® HK70MR from Ashland Aqualon Functional Ingredients (Wilmington, Del.); Bermocoll CCA098, Bermocoll CCA425, Bermocoll E511X, Bermocoll M 30, Bermocoll M 70, Bermocoll EBM 50, Bermocoll EBM 8000 from AKZO Nobel Surface Chemistry (Chicago, Ill.); and Waloce10 MW15000 PFV, Walocel® MK 25000 PFV, Walocel® MKX 20000 PP 10, Walocel® MKX 45000 PP 10 from Dow Chemical Company (Midland, Mich.).

The first water retention agent is present in an amount of up to about 5% by weight, or from about 0.1% by weight, or from about 0.2% by weight, or from about 0.25% by weight to about 1% by weight, or to about 2% by weight, or to about 5% by weight, based on the weight of the cementitious composition.

Examples of the second water retention agents include such as polyacrylamide polymers; clays such as attapulgite clay, bentonite clay, and kaolin clay; alkali swellable polyacrylate polymers; starch ethers; polysaccharide derivatives such as guar gum, welan gum, and diutan gum; and combinations thereof. Examples of commercially available second water retention agents include such as K1A96 Welan Gum and Kelco-Crete® DG Line from CP Kelco (Atlanta, Ga.); Min-U-Gel FG from Active Minerals International LLC (Hunt Valley, Md.); Benaqua® 1000, Benaqua® 4000, Bentone® CT, and Bentone® OC from Elementis Specialties, Inc (Highstown, N.J.); and Tylovis SE7 from SE Tylose GmbH & Co. (Wiesbaden, Germany).

The second water retention agent may be present in the cementitious composition in an amount of up to about 5% by weight. In one embodiment in which it is used in combination with the first water retention agent, the second water retention agent may be present in an amount of from about 0.001% by weight to about 5% by weight, based on the weight of the cementitious composition. In one embodiment in which it is used as the one water retention agent, the second water retention agent may be present in an amount of from about 0.1% by weight to about 5% by weight, based on the weight of the cementitious composition.

In some embodiments, in which the water retention agent includes a combination of a first water retention agent and a second water retention agent, the first and the second water retention agents can be in a ratio of from about 0.001 parts by weight, or from about 0.01 parts by weight, or from about 0.10 parts by weight to about 5 parts by weight, or to about 10 parts by weight, or to about 20 parts, or to about 30 parts by weight, or to about 40 parts by weight of the second water retention agent per 1 part by weight of the first water retention agent.

In some embodiments, the water retention agent is present in the cementitious composition such that the weight ratio of the total water retention agent(s) to the superplasticizer is from about 0.02, or from about 0.1 or from about 0.4, or from about 0.6 to about 4, or to about 6, or to about 10, or to about 15, or to about 20, or to about 25.

The cementitious composition may also include one or more additional additives that are in dry form such as re-dispersible polymer powders (e.g., spray dried latex); setting accelerators; setting retarders; defoamers; antimicrobial and/or anti-fungal additives; water repellants; oil repellants; surfactants; pigment and/or clay dispersants e.g., Tamol 731DP; organic or mineral pigments, calcium carbonate, pozzolanic fillers, gypsum, dust reducing additives, and combinations thereof.

In some embodiments, a liquid additive at room temperature e.g., a liquid accelerator may be included in the cementitious composition after the liquid ingredient is treated such that it is in a dry form at room temperature. Examples of a dry form of liquid additives include e.g., re-dispersible polymer powders, or being carried by a dry carrier material. In latter case, a dry form of a liquid accelerator e.g., triethanolamine, which is absorbed onto a dry carrier material e.g., fumed silica, or a dry form of a liquid defoamer e.g., silicone-based defoamer, which is adsorbed onto a dry carrier, e.g. calcium carbonate, can be added to the cementitious composition.

The pigment and/or clay dispersants are additives that disperse mineral pigment and clay and/or filler agglomerates in a cementitious composition during the mixing with water or an aqueous component. In some cases, these dispersants may also be considered as low range water reducers, which reduce the water demand of a cementitious composition by less than 15% relative to a cementitious composition without a water reducer. Examples of the pigment and/or clay dispersants include e.g., Tamol 731 DP from Dow Chemical company (Midland, Mich.); Metolat P-588 from Munzing Chemie GmbH (Bloomfield, N.J.); and Surfynol 104S from Air Products and Chemicals, Inc. (Allentown, Pa.).

The setting accelerator refers to cement accelerators, i.e., they accelerate the hydration reaction of a cementitious material with water. Examples of useful accelerators include such as aluminum sulphate, calcium chloride, calcium formate, lithium silicate, lithium carbonate, lithium hydroxide, lithium sulfate, lithium chloride, metasilicates e.g., magnesium silicate, potassium silicate, sodium carbonate, sodium silicate, sodium nitrite, sodium nitrate, sodium thiocyanate, sodium thiosulphate, triethanolamine, and combinations thereof. The accelerator may be present in the cementitious composition in an amount of up to about 10% by weight, or from about 0.01% by weight, or from about 0.1% by weight, or from about 0.5% by weight to about 5% by weight, or to about 10% by weight, based on the weight of the cementitious composition.

The cementitious composition of the invention can be prepared according to any known mixing methods, and the particular methodology employed is not critical. For example, the desired ingredients may simply be placed in an appropriate container in appropriate amounts and mixed until a substantially uniform dry powder mixture is achieved.

In some embodiments, a cementitious composition in accordance with the invention is prepackaged with predetermined amounts of all the ingredients required for a particular cementitious product such as a mortar or a grout. The package used for the cementitious composition may include instructions on the amount of an aqueous component to be added to the composition to obtain the mortar or the grout, and/or how to mix the mortar or the grout, and/or how to achieve the easy-to-mix characteristic of the mortar or the grout.

The cementitious composition, upon mixing with an aqueous component at the point of use, can be used as a cement-based mortar/grout, e.g., a tile setting mortar or a tile grout.

In one embodiment, a cement-based mortar/grout of the invention, e.g., a tile setting mortar or a tile grout includes a cementitious composition and an aqueous component.

The aqueous component includes at least about 30% by weight of water, or from about 50% by weight, or from about 60% by weight to about 85% by weight, or to about 95% by weight, or to about 100% by weight of water, based on the weight of the aqueous component.

Examples of suitable aqueous components include water, water based admixtures for cement-based compositions, e.g., acrylic admixture; water-based admixtures e.g., Grout Boost® Stain Resistant Grout Additive commercially available from H.B. Fuller Construction Products Inc (Aurora, Ill.); water based emulsions, dispersions, suspensions, or solutions e.g., polymer latexes; additives in liquid form including e.g., stain resistant additives; superplasticizers, set accelerators, set retarders, shrinkage reducing agents; and combinations thereof.

In one embodiment, the aqueous component is a water-based admixture.

The water-based admixtures for cement-based mortar/grout may include various ingredients such as defoamers such as OCTAFOAM E305 from Octel Performance Chemicals Inc. (Milwaukee, Wis.), FOAMASTER NXZ from Cognis USA (Cincinnati, Ohio); biocides e.g., ACTICIDE RS from Acti-Chem Specialties Inc. (Trumbull, Conn.), KATHON LX 1.5% from Dow Chemical Company (Midland, Mich.); water reducers/superplasticizers such as polycarboxylates e.g., MELFLUX 2651F from BASF Construction Polymers (Kennesaw, Ga.) and SOKALAN DS 3557 from BASF Corporation (Charlotte, N.C.), melamine formaldehyde condensates e.g., MELMENT F 10 and F 15 from BASF Construction Polymers, naphthalene sulfonates, and casein; water retention agents such as cellulose e.g., TYLOSE from SE Tylose GMBH & Co. (Wiesbaden, Germany), CULMINAL and NEXTON from Ashland Aqualon Functional Ingredients (Wilmington, Del.), BERMOCOLL from AKZO Nobel Surface Chemistry (Chicago, Ill.), and WALOCEL from Dow Chemical Company; pigment dispersants such as TAMOL 731 A from Dow Chemical Company; various accelerators; various polymer latexes; and combinations thereof.

Examples of useful polymer latexes include such as acrylic latexes or dispersions, such as those commercially available under the trade designations RHOPLEX E-330, RHOPLEX MC-76 and RHOPLEX MC-1834 from Dow Chemical Company; acrylic copolymer emulsions e.g., NACRYLIC CP-3600 from Celanese Ltd. (Dallas, Tex.), PD-0725-P from H.B. Fuller (St. Paul, Minn.), and VINNAPAS CP 67 from Wacker Chemical Corp; styrene acrylic emulsions e.g., ACRONAL NX3717 and ACRONAL S-702 from BASF Corporation (Florham Park, N.J.); ethylene vinyl acetate copolymer emulsions e.g., DURO-O-SET CP-3610 from Celanese Ltd; vinyl versatate emulsions; silanated polymer latexes such as silanated acrylic latexes, which are commercially available under the trade designations AXILAT DS931 (Hexion Specialty Chemicals, Columbus, Ohio), NX2835 (BASF Inc., Charlotte, N.C.), and 13057 (Scott Bader, Northamptonshire, England); polyurethane dispersions such as NEORES 9649 or 9699 from Neoresins; and an acrylic/polyurethane dispersion that is a stabilized hybrid dispersion with enhanced interaction between the urethane and acrylic moieties, rather than a simple blend.

Examples of commercially available stabilized hybrid dispersions include those available under the trade designations HYBRIDUR from Air Products and Chemicals Inc. (Allentown, Pa.), and NEOPAC (grades E 125 and E114), from NeoResins (Wilmington, Mass.).

In one embodiment, the water-based admixture includes at least about 30% by weight of water, or from about 50% by weight, or from about 60% by weight to about 85% by weight, or to about 95% by weight, or to about 99.5% by weight of water, based on the weight of the aqueous component.

In some embodiments, the water-based admixture includes from about 0.5% by weight to about 20% by weight at least one superplasticizer, from 0% by weight, or from about 0.1% by weight to about 10% by weight at least one water retention agent, and from 0% by weight, or from about 0.1% by weight to about 10% by weight at least one accelerator, based on the weight of the water-based admixture.

In one embodiment, the water-based admixture further includes at least one polymer latex. In one embodiment, the water-based admixture includes from about 1% by weight to about 30% by weight of the polymer latex, based on the weight of the water-based admixture.

In some embodiments, the aqueous component is present in the cement-based mortar/grout in an amount of from about 15% by weight, or from about 20% to about 60% by weight, or to about 75% by weight, based on the weight of the cementitious composition.

The cement-based mortar/grout of the invention can be prepared according to any known method of making a grout or mortar so long as the aqueous component and the cementitious composition of the invention can be mixed uniformly, and the particular methodology employed is not critical. For example, the aqueous component and the cementitious composition can simply be placed in an appropriate container in appropriate amounts at the job site and mixed until a substantially uniform or consistent mortar is obtained.

In some embodiments, the cement-based mortar/grout of the invention is prepared by mixing, at the point of use, the cementitious composition of the invention with an aqueous component to form a paste that has an initial viscosity of no greater than about 150,000 cps, or even no greater than about 100,000 cps. The paste is then allowed to stand for a period, e.g., from about 10 to about 20 minutes so that the viscosity of the paste increases to no less than about 250,000 cps, or no less than about 300,000 cps, when tested at about 20 minutes from the initial mixing. In some embodiments, the viscosity of the paste increases to no less than about 300,000 cps when tested at about 20 minutes from the initial mixing.

In one embodiment, the mixing is conducted by hand using a handy tool, e.g., a trowel. The lower initial viscosity of the paste, e.g., no greater than about 150,000 cps, or even no greater than about 100,000 cps, allows one to mix the paste easily by the handy tool at a job site e.g., at home without the need for a mechanical mixer/force. At the end of the slaking period e.g., in about 10 minutes to about 20 minutes, the viscosity of the paste quickly builds up to a desired level, e.g., at least about 250,000 cps, or no less than about 300,000 cps, or higher when tested at 20 minutes from initial mixing. At this point the paste achieves its necessary thickness that allows one to apply the mortar to a surface or a substrate to be tiled without encountering any problems such as tile's slipping down on the vertical surface e.g., a wall, or slumping on a horizontal surface e.g., on a floor application.

In one embodiment, the cement-based mortar/grout of the invention is used as a tile setting mortar. The mortar can be applied on a horizontal surface/substrate e.g., a floor or a vertical surface e.g., a wall. Tiles are then placed on the top surface of the mortar, which is then cured to set the tiles.

In one embodiment, the cement-based mortar/grout of the invention is used as a grout for grouting tile joints. The grout is applied to the joins of tiles and cured.

The invention will be described further by way of the following examples. All parts, ratios, percents, and amounts stated in the examples are by weight unless otherwise specified.

### EXAMPLES

### Test Methods

### Viscosity

The viscosity of a cement-based mortar/grout is tested at 73° F.+/−3° F. according to the following test method.

### Equipment:

A Brookfield HAT Viscometer with a Helipath stand and a TE Spindle.

### Test Procedure:

Adding 200.0±0.01 grams of a cementitious composition in dry powder form into a first 16 oz. plastic cup and a specified amount of a specified aqueous component at room temperature into a second 16 oz plastic cup. Adding the cementitious composition in the first cup into the aqueous component in the second cup and stirring slowly with a 4″ spatula until the powder is wetted, then, vigorously until a homogeneous paste is achieved. Measuring the viscosity of the paste using a Brookfield HAT Viscometer at 5 rpm speed and rotation for 30 seconds; reporting the viscosity value as the initial viscosity. At 20 minutes from the initial mixing, re-mixing the paste with the spatula, and measuring the viscosity of the paste again. Reporting the viscosity value as the 20 minute viscosity. Reporting average of two (2) to three (3) samples each time.

### Shear Bond Strength I

Shear bond strength I of a cured cement-based mortar/grout is tested and evaluated according to the American National Standard Specifications for Latex-Portland Cement Mortars for the Installation of Ceramic Tile, A118.4-1999 (reaffirmed 2005).

### Shear Bond Strength II

Shear bond strength II of a cured cement-based mortar/grout is tested and evaluated according to the American National Standard Specifications for EGP (Exterior Glue Plywood) Latex-Portland Cement Mortars for the Installation of Ceramic Tile, A 118.11-1999 (reaffirmed 2005).

### Cement-Based Mortar Base Compositions 1-4

Each of the cement-based mortar base compositions 1-4 is prepared by combining the ingredients according to Table 1 in an appropriate mixing container until a uniform consistent dry powder mixture is formed.

TABLE 1

| | Mortar Base 1 | Mortar Base 2 | Mortar Base 3 | Mortar Base 4 |
|---|---|---|---|---|
| Silica Sand (40-140 mesh) | 61.51 | 61.485 | 61.505 | 61.72 |
| Gray Type I Portland | 26 | 26 | 26 | 26.089 |
| Cement | | | | |
| Calcium Carbonate | 2.5 | 2.5 | 2.5 | 2.509 |
| Type C Fly Ash | 6.5 | 6.5 | 6.5 | 6.522 |
| Calcium Formate | 0.4 | 0.4 | 0.4 | 0.401 |
| Polyacrylamide Powder | | 0.025 | 0.005 | |
| (viscosity* of 1250-1800 | | | | |
| mPAS) | | | | |
| Methylhydroxyethyl/ | 0.34 | 0.34 | 0.34 | |
| hydroxypropyl Cellulose | | | | |
| (viscosity ** of 30,000 | | | | |
| mPAS) | | | | |
| Vinyl Acetate/Ethylene | 2.75 | 2.75 | 2.75 | 2.759 |
| Copolymer Powder | | | | |
| (Tg 15° C. +/− 5° C.) | | | | |

*measured as 5g/l solution at 20° C. using Brookfield RVT viscometer at 20 rpm.
** measured as 2% solution at 20° C. using Brookfield RVT viscometer at 20 rpm.

### Control 1 and Examples 1-3

Cement-based mortars of Control 1 and Examples 1-3 are prepared by combining the ingredients according to Table 2 in an appropriate mixing container. The initial viscosity and the viscosity at 20 minutes are tested according to the viscosity test method. The results are also listed in Table 2.

TABLE 2

| Examples | Control 1 | Example 1 | Example 2 | Example 3 |
|---|---|---|---|---|
| Mortar Base 1 | 100 | 99.5 | 98 | 98 |
| Conpac 500 | | 0.5 | | |
| Melment F10 | | | | 2 |
| Type 500 Casein | | | 2 | |
| Water | 20 | 22.5 | 27 | 21 |
| Initial | 400,000 | 80,000 | 140,000 | 85,000 |
| viscosity (cps) | | | | |
| 20 min. | 400,000 | 260,000 | 380,000 | 320,000 |
| viscosity (cps) | | | | |
| Superplasticizer/ | | 0.0155 | 0.0628 | 0.0628 |
| Cement | | | | |
| Ratio | | | | |
| Total Water | | 0.68 | 0.17 | 0.17 |
| Retention | | | | |
| Agents/ | | | | |
| Superplasticizer | | | | |
| Ratio | | | | |

### Examples 4-8

Cement-based mortars of Examples 4-8 are prepared by combining the ingredients according to Table 3 in an appropriate mixing container. The initial viscosity and the viscosity at 20 minutes are tested according to the viscosity test method. The results are also listed in Table 3.

TABLE 3

| Examples | Example 4 | Example 5 | Example 6 | Example 7 | Example 8 |
|---|---|---|---|---|---|
| Mortar Base 1 | 99 | | | | |
| Mortar Base 2 | | 99.5 | | | |
| Mortar Base 3 | | | 99.5 | | |
| Mortar Base 4 | | | | 98.5 | 99.3 |
| Conpac 500 | | 0.5 | 0.5 | 0.5 | 0.5 |
| Type 500 Casein | 1.0 | | | | |
| Tylovis SE7 | | | | 1 | |
| Walocel MW 40000 PFV | | | | | 0.2 |
| Water | 28 | 20 | 20 | 21 | 17 |
| Initial viscosity (cps) | 90,000 | 90,000 | 90,000 | 110,000 | 95,000 |
| 20 min. viscosity (cps) | 300,000 | 560,000 | 400,000 | 320,000 | 310,000 |
| Superplasticizer/Cement | 0.0311 | 0.0155 | 0.0155 | 0.0156 | 0.0154 |
| Ratio | | | | | |
| Total Water Retention | 0.34 | 0.73 | 0.69 | 2 | 0.4 |
| Agents/Superplasticizer | | | | | |
| Ratio | | | | | |
| First Water | | 0.0735 | 0.0147 | | |
| Retention/ | | | | | |
| Second Water | | | | | |
| Retention | | | | | |
| Agent Ratio | | | | | |

### Examples 9-12

Cement-based mortars of Examples 9-12 are prepared by combining ingredients according to Table 4 in an appropriate mixing container. The initial viscosity and the viscosity at 20 minutes are tested according to the viscosity test method. The results are also listed in Table 4.

TABLE 4

| | Example | Example | Example | Example |
|---|---|---|---|---|
| Examples | 9 | 10 | 11 | 12 |
| Mortar Base 1 | 98.5 | 99 | 98.5 | 98 |
| Optibent 987 | 1 | | | |
| Min-U-Gel FG | | | | 1.5 |
| Rheolate 101 | | 0.5 | | |
| Attapulgite Gel B | | | 0.5 | |
| Conpac 500 | 0.5 | | | 0.5 |
| Melflux 2641F | | 0.5 | | |
| Melment F10 | | | 1 | |
| Water | 21 | 23 | 22 | 22 |
| Initial | 100,000 | 150,000 | 140,000 | 80,000 |
| viscosity cps | | | | |
| 20 min. | 360,000 | 400,000 | 300,000 | 260,000 |
| viscosity cps | | | | |
| Superplasticizer/ | 0.0156 | 0.0155 | 0.0312 | 0.0157 |
| Cement Ratio | | | | |
| Total Water | 2.68 | 1.68 | 0.84 | 3.68 |
| Retention Agents/ | | | | |
| Superplasticizer | | | | |
| Ratio | | | | |
| First Water | 2.941 | 1.471 | 1.471 | 4.412 |
| Retention/ | | | | |
| Second Water | | | | |
| Retention | | | | |
| Agent Ratio | | | | |

### Water-Based Admixtures 1-3

Each of the water-based admixtures 1-3 is prepared by combining the ingredients according to Table 5 in an appropriate mixing container until a uniform consistent mixture is formed.

TABLE 5

| | Admixture 1 | Admixture 2 | Admixture 3 |
|---|---|---|---|
| Water | 965 | 964 | 955 |
| Melflux 2651 | 35 | 35 | 35 |
| Calcium Formate | | 10 | 10 |
| Polyacrylamide Powder | | 1 | |
| (viscosity of 1250-1800 | | | |
| mPAS) | | | |

### Control 1 and Examples 13-15

Cement-based mortars of Control 1 and Examples 13-15 are prepared by combining the ingredients according to Table 6 in an appropriate mixing container. The initial viscosity and the viscosity at 20 minutes are tested according to the viscosity test method. The results are also listed in Table 6.

TABLE 6

| Examples | Control 1 | Example 13 | Example 14 | Example 15 |
|---|---|---|---|---|
| Mortar Base 1 | 100 | 100 | | |
| Mortar Base 3 | | | 100 | 100 |
| Admixture 1 | | | 22 | |
| Admixture 2 | | 21 | | |
| Admixture 3 | | | | 20.5 |
| Water | 20 | | | |
| Initial | 400,000 | 130,000 | 70,000 | 110,000 |
| viscosity (cps) | | | | |
| 20 min. | 400,000 | 290,000 | 260,000 | 330,000 |
| viscosity (cps) | | | | |
| Superplasticizer/ | | 0.0224 | 0.0237 | 0.0237 |
| Cement Ratio | | | | |
| Total Water | | 0.496 | 0.448 | 0.448 |
| Retention Agents/ | | | | |
| Superplasticizer | | | | |
| Ratio | | | | |
| First Water | | 0.612 | 0.0147 | 0.0147 |
| Retention/ | | | | |
| Second Water | | | | |
| Retention | | | | |
| Agent Ratio | | | | |

The embodiments of the invention described above are not intended to be exhaustive or to limit the invention to the particular embodiments disclosed in the following detailed description. Rather, the embodiments are described so that others skilled in the art can understand the principles and practices of the invention. Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

We claim:

1. A cementitious composition, comprising
at least one cementitious material,
at least one aggregate,
from about 0.2% by weight to about 5% by weight of at least one superplasticizer,
from about 0.1% by weight to about 5% by weight of at least one water retention agent selected from the group consisting of a first water retention agent, a second water retention agent, and combinations thereof,
the composition, upon mixing with an aqueous component, having an initial viscosity of no greater than about 150,000 cps, and a 20 minute viscosity of no less than about 250,000 cps.

2. The cementitious composition of claim 1, wherein the first water retention agent is a water soluble cellulose ether, which comprises a hydroxyethyl cellulose, methylhydroxyethyl cellulose, methylhydroxypropyl cellulose, and combinations thereof.

3. The cementitious composition of claim 2, wherein the first water retention agent is in an amount of from about 0.1% by weight to about 2% by weight.

4. The cementitious composition of claim 1, wherein the second water retention agent comprises a polyacrylamide polymer, an attapulgite clay, a bentonite clay, a kaolin clay, an alkali swellable polyacrylate polymer, starch ethers, polysaccharide derivatives such as guar gum, welan gum, and diutan gum; and combinations thereof.

5. The cementitious composition of claim 4, wherein the second water retention agent is in an amount of from about 0.001% by weight to about 5% by weight.

6. The cementitious composition of claim 2, wherein the first and the second water retention agents are in a weight ratio of 1 part of the first retention agent to from about 0.001 part to about 40 parts of the second water retention agent.

7. The cementitious composition of claim 1, wherein the superplasticizer comprises polycarboxylate based superplasticizers, sulfonated melamine-formaldehyde condensate superplasticizers, casein, modified lignosulfonate superplasticizers, sulfonated naphthalene-formaldehyde condensate superplasticizers, and combinations thereof.

8. The cementitious composition of claim 1, further comprises one or more additives chosen from re-dispersible polymer powders; setting accelerators; setting retarders; defoamers; anti-microbial and/or anti-fungal additives; water repellants; oil repellants; surfactants; pigment and/or clay dispersants; organic or mineral pigments, calcium carbonate, pozzolanic fillers, gypsum, dust reducing additives, and combinations thereof.

9. The cementitious composition of claim 1, wherein the weight ratio of the superplasticizer to the cementitious material is from about 0.002 to about 0.35.

10. The cementitious composition of claim 1, wherein the weight ratio of the water retention agent to the superplasticizer is from about 0.02 to about 25.

11. A cement-based mortar/grout comprising the cementitious composition of claim 1 and from about 15% by weight to about 75% by weight of an aqueous component.

12. The cement-based mortar/grout of claim 11, wherein the aqueous component is selected from the group consisting of water; a water-based admixture; a water-based emulsion, dispersion, suspension, or solution; and combinations thereof.

13. The cement-based mortar/grout of claim 11, wherein the aqueous component is a water-based admixture that comprises from about 0.5% by weight to about 20% by weight at least one superplasticizer.

14. The cementitious composition of claim 13, wherein the water-based admixture further comprises a polymer latex in an amount of from about 1% by weight to about 30% by weight.

15. A method of making a cement-based mortar/grout, comprising
mixing a cementitious composition with an aqueous component to form a paste that has an initial viscosity of no greater than about 150,000 cps; and a viscosity of no less than about 250,000 cps at about 20 minutes from the initial mixing,
wherein the cement-based mortar/grout comprises at least one cementitious material, from about 0.2% by weight to about 5% by weight of at least one superplasticizer, from about 0.1% by weight to about 5% by weight of at least one water retention agent, and from about 0.01% by weight to about 10% by weight of at least one accelerator.

16. The method of claim 15, wherein the mixing is achieved by hand mixing without using a mechanical mixer.

17. The method of claim 15 wherein the superplasticizer, the water retention agent, and/or the accelerator are in the aqueous component prior to mixing.

18. A method for setting tiles, comprising
mixing the cementitious composition of claim 1 with an aqueous component to form a paste that has an initial viscosity of no greater than about 150,000 cps;
allowing the paste to stand for a period to form a trowelable mortar that has a viscosity of no less than about 250,000 cps at about 20 minutes from the initial mixing;
applying a layer of the mortar to a substrate to be tiled;
placing tiles on the layer of the mortar; and
curing the mortar to set the tiles.

19. A method for grouting a tile joint, comprising
mixing the cementitious composition of claim 1 with an aqueous component to form a paste that has an initial viscosity of no greater than about 150,000 cps;
allowing the paste to stand for a period to form a trowelable grout that has a viscosity of no less than about 250,000 cps at 20 minutes from the initial mixing;
applying the grout to the joint; and
curing the grout.

20. A cement-based mortar/grout, comprising
a cementations composition comprising a cementitious material and at least one water retention agent, and
a water-based admixture comprising
from about 0.5% by weight to about 20% by weight at least one superplasticizer;
at least one water retention agent, or
at least one accelerator,
wherein the cementitious composition and the water-based admixture are kept separate until at the point of use, and wherein the mortar has, upon mixing the cementitious composition with the water-based admixture at the point of use, an initial viscosity of no greater than about 150,000 cps, and a 20 minute viscosity of no less than about 250,000 cps.

21. The cement-based composition of claim 20, further comprising a polymer latex in an amount of from about 1% by weight to about 30% by weight.

22. A package for the cementitious composition of claim 1, comprising an amount of the composition, and instructions comprising how to mix the composition with an aqueous component to obtain an easy-to-mix cement-based mortar/grout.
